(19) United States
(12) Patent Application Publication
(10) Pub. No.: US 2011/0044032 A1
(43) Pub. Date: Feb. 24, 2011

(54) Apparatus With Electric Element Powered By A Capacitive, Ceramic-Based Electrical Energy Storage Unit (EESU)

(76) Inventor: JOHN BOYD MILLER, (US)

Correspondence Address: John B. Miller, 4000 Preston Lakes Circle, Celina, TX, 75009, US

(21) Appl. No.: 12/858,610

(22) Filed: Aug. 18, 2010

Related U.S. Application Data
(60) Provisional application No. 61/274,517, filed on Aug. 18, 2009.

(51) Int. Cl. F21L 4/00; H02J 7/00; H02P 1/00

(52) U.S. Cl. 362/157; 320/166; 318/139

(57) ABSTRACT

Within an apparatus (20), the primary energy source for an electrical-energy-using element (electric element) (30) is a capacitive, ceramic-based electrical energy storage system (EESU) (100).

### CROSS REFERENCE TO RELATED APPLICATIONS 61/274,517

This Non-Provisional Application Claims The Benefit of The Priority Date of Provisional Application No. 61/274,517 Filed 18 Aug. 2009.

### FEDERALLY SPONSORED RESEARCH

Not Applicable

### SEQUENCE LISTING OR PROGRAM

Not Applicable

### BACKGROUND OF THE INVENTION

1. Field of Invention

This invention relates to an electrical apparatus utilizing a ceramic-based capacitive-storage power source, specifically, any electrical, electronic or motorized apparatus that utilizes a capacitive, ceramic-based electrical energy storage unit (EESU) power source.

2. Background of the Invention

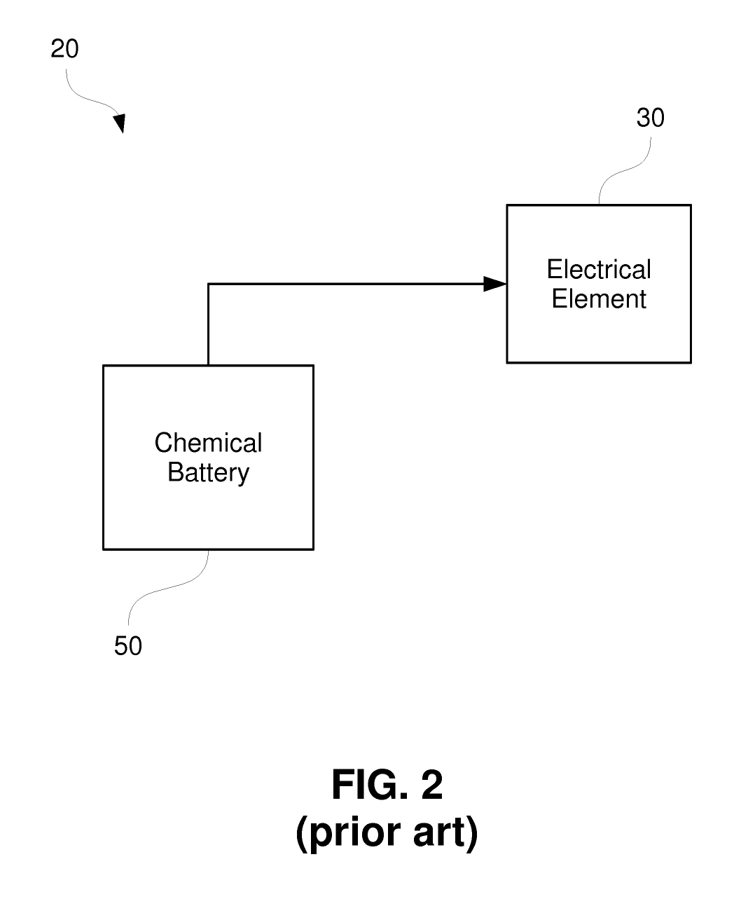

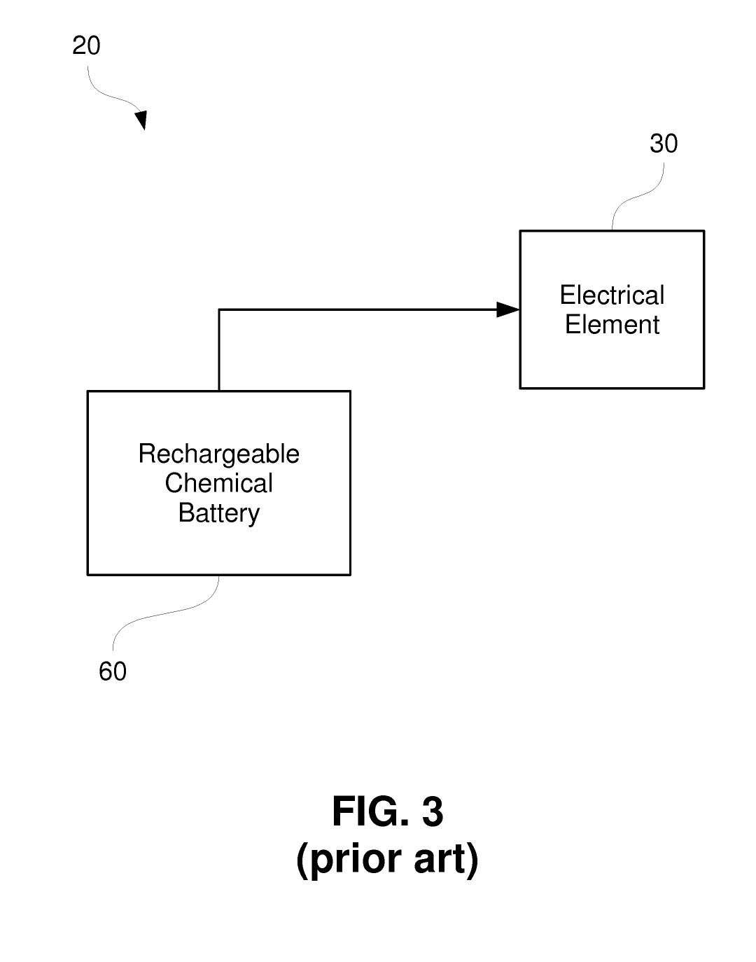

There are many devices that currently utilize chemical battery electric power as their primary energy source, FIGS. 2 and 3. A key feature of these devices is the convenience of not needing to be tethered to an electrical source such as a wall socket via a cord. This makes them highly portable and convenient.

Many electric and electronic devices utilize batteries in order to allow them to become portable. Examples are children's toys, personal electronics like cameras, radios and TVs, mp3 players and boom boxes, GPS devices and cell phones, computing equipment like notebook computers, home and work tools such as flashlights, screwdrivers, drills, and saws, portable test equipment such as portable oscilloscopes, logic analyzers or protocol analyzers, portable medical electronics, and vehicles such as golf carts and automobiles.

For devices that use non-rechargeable batteries, FIG. 2, an advantage is that battery change-out is quick. Disadvantages to using this type of battery include not having new batteries when a user needs them, having to store extra batteries since a user never knows when they will need fresh batteries, the cost of continually changing out batteries, and throwing away used batteries and creating waste and pollution issues for the environment.

For devices that use rechargeable batteries, FIG. 3, while there is the convenience, usefulness, and sometimes a cost advantage of the recharge capability, a disadvantage to using this type of battery in a device is that when the battery becomes run down with use, that is, when electrical energy is depleted from the battery, the battery must either be recharged for long periods of time, sometimes for hours, before being available for use again, or it must be replaced by a charged battery to allow the run down battery to be recharged in a charging unit over time. Re-use within minutes is generally not a feature of these batteries and this is one drawback of this power source.

These rechargeable batteries, while potentially lasting for many recharge cycles, get to a point where they can no longer hold a charge, they become marginally useful, and ultimately they must be disposed of. As they are disposed of, they require time, effort and cost to recycle them, or, as with non-rechargeable batteries, if they are not recycled they create waste and possibly pollution.

Another concern to users is the availability issue when it comes time for a user to replace a rechargeable battery at the end of its useful life. For example, in notebook computers, when a battery must be replaced, a user must go to the computer manufacturer or search for an equivalent replacement. Each of these methods is time consuming, will generally take days to get a new battery, and is usually somewhat costly for users.

Both rechargeable and non-rechargeable batteries have shelf life issues. Shelf life is the amount of time a chemical battery can sit on a shelf before its chemistry degrades to the point that it will no longer hold a charge. The longest shelf life for popular batteries is about ten years, after which they must be replaced. Most Lithium-Ion (LiIon) batteries have a shelf life of ten years, while popular alkaline AA or AAA batteries have a shelf life of only three or four years.

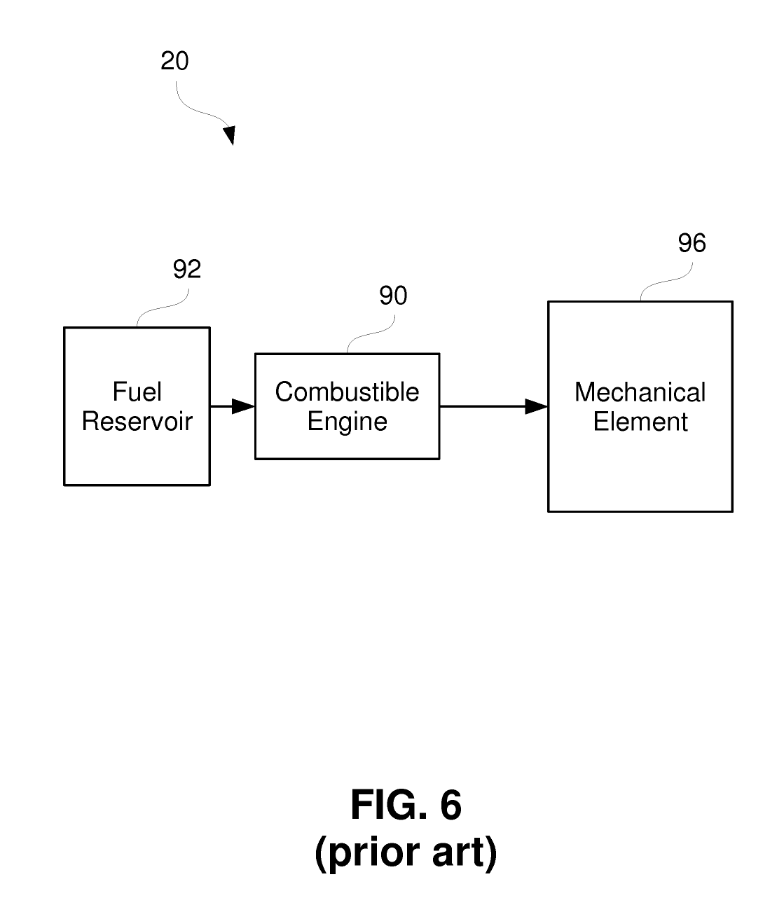

Many portable devices utilize gasoline, diesel, propane, or natural gas powered engines to provide their portable energy, FIG. 6. Examples of such devices are gas powered yard maintenance tools such as mowers, trimmers and blowers. Other examples are portable road signs with gas powered engines that generate electrical energy to power the signs. Yet other examples are vehicles, watercraft, and aircraft. Even some spacecraft systems may enter into this category. Still others include portable electric generators or backup generators that utilize gasoline, diesel, propane or natural gas powered engines to provide emergency power to homes or other locations when another source of power is not available.

For devices that utilize gasoline, diesel, propane, or natural gas powered engines, the advantages are quite apparent in that with a little combustible fuel, devices can provide a useful amount of work. The disadvantages to utilizing this type of power for a portable apparatus include the requirements of handling, storage, and delivery of dangerous toxic and explosive fuels. Another disadvantage of this type of power generation is that these engines require regular maintenance to perform properly. When regular maintenance is not performed, these engines tend to degrade quickly. Maintenance of these engines also requires the use, storage, and handling of somewhat messy lubrication oils. Gasoline and diesel exhaust is also a contributor to pollution.

### OBJECTS AND ADVANTAGES

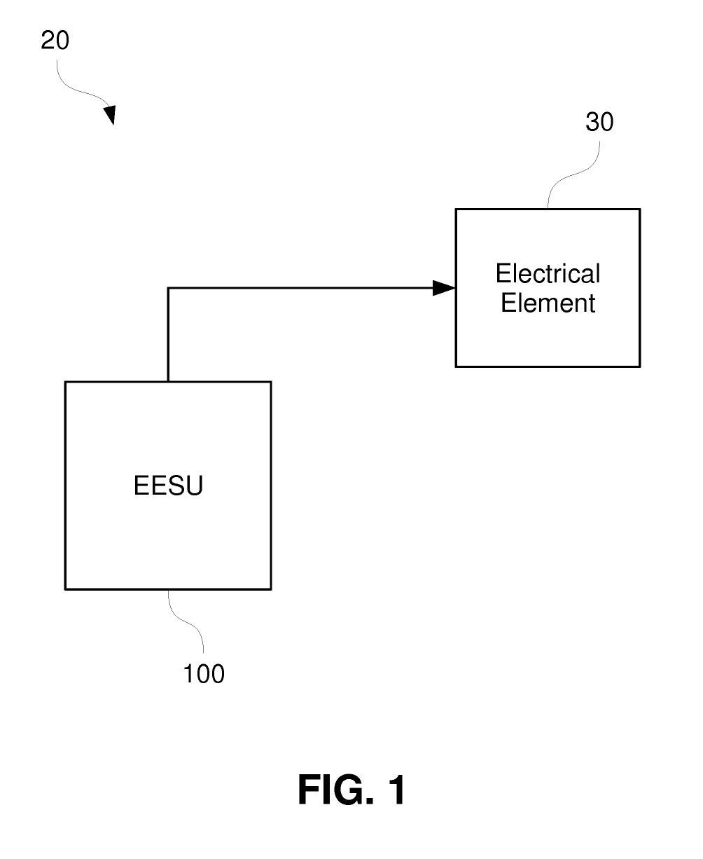

Accordingly, a solution to these issues is an apparatus that includes an electrical-energy-using element (electrical element) such as a light, a display, an electrical or electronic circuit, a motor, an electro-mechanical component, or a combination of electrical elements, that is powered by a capacitive, ceramic-based electrical energy storage unit (EESU) that is capable of storing large amounts of energy in a dense area, that is capable of recharging quickly, that does not show significant degradation over time, that does not show significant shelf-life issues, and that has minimal impact on the environment, FIG. 1.

An example of such a high density, capacitive, ceramic-based electrical energy storage unit is the Electrical-Energy-Storage Unit (EESU) of Richard Dean Weir, U.S. Pat. No. 7,466,536 B1. The preferred embodiment of this referenced patent shows that integrated circuit techniques are utilized to sinter extremely high permittivity Barium Titanate crystals into a bulk ceramic substrate giving a very high-density capacitive energy storage capability. The referenced patent discusses a complete ceramic-based EESU with 31,351 capacitive elements connected in parallel giving a total storage capacity of 52 kilowatt-hours (kWh) at a weight of 336 pounds. This is enough electrical energy to power a vehicle for 300 miles. Other qualities are that the EESU of the above referenced patent can be charged in about five minutes, has a long shelf-life since it self-discharges slower than batteries, and it is non-explosive, non-toxic, and non-hazardous. According to TABLE 1 of the referenced patent, this EESU gives over twice the energy density of LiIon batteries and over five times the energy density of NiMH or any other high-density chemistry-based batteries.

The above referenced patent covers an apparatus that is in and of itself a high density, capacitive, ceramic-based electrical energy storage unit (EESU). Versions of this EESU storage system, or other similar ceramic-based electrical energy storage units, can be made in various sizes, energy capacities and operating voltages to power small devices, large devices, and devices of any other size. By combining an EESU of appropriate size, energy capacity, and voltage to deliver energy to an electrical element such as a light, a display, an electrical or electronic system, a motor, or an electro-mechanical system, an apparatus of this invention is created. Many useful portable and non-portable devices of this invention can be created, including the exemplary battery-based devices as mentioned above, as well as electric equivalents of the combustible engine based devices mentioned above.

Advantages of the current invention over prior art chemical battery-based devices include that an apparatus of the current invention will give the user a power source with a nearly unlimited lifetime. This is due to the EESU power source within such a device allowing a nearly unlimited number of recharge cycles with little degradation. On the other hand, batteries in battery-based systems degrade with usage and can be recharged only a limited number of times before their energy storing capabilities degrade to the point that the batteries need to be replaced. This invention also has an advantage over an apparatus with a chemical based battery in that the EESU power source of this invention requires only that charge be transferred from a power source, such as an electrical outlet, to the EESU, and does not require the slow process of a chemistry change and the required measured timing for such a process as with chemical-based batteries. Recharging the current invention can therefore be accomplished in minutes via a charging circuit plugged into the current electric grid. For devices of this invention that utilize more power, such as mowers and lawn care equipment, the EESU within these devices can be charged quickly with a high performance charger, they can be charged slowly over time, such as overnight, or they can even be changed out quickly for a charged device as with prior art battery powered tools.

Size and weight are another advantage for an apparatus of the current invention since the energy density of the EESU power source within the device is more dense than batteries and is therefore lighter for a given power storage capability. Therefore both the size and the weight of an apparatus of the current invention can be less than with devices based on prior art chemical batteries for most energy storage capacities.

An obvious advantage of the current invention is that since an EESU power source has a nearly unlimited useful life, costs and inconvenience associated with power source replacement will be nearly eliminated, not to mention minimizing the waste, and possibly the toxic waste, associated with the disposal of millions of chemical-based batteries yearly as with prior art devices. There will also be no need to utilize energy to recycle millions of recyclable batteries when using devices of this invention.

Another advantage of this invention is that it will power relatively clean and efficient electric motors that can replace polluting combustible engines in many devices. These clean electric motors are generally more efficient than combustible engines, they will not require the handling of fuels, nor will they require regular oil changes and the associated efforts required for recycling oil as with combustible engines. Also, since there is generally much less maintenance on an electric motor than with combustible engines, reliability issues can be minimized and cost savings can be realized. Even energy availability will be less of an issue with a device of this invention since energy recharge is accomplished by connecting anywhere to the currently available electric grid. For yard equipment, a user will no longer be required to take the time, effort and cost to drive to a gas station and then to store messy and potentially dangerous fuels at their home or work location. Utilizing this invention in devices instead of gas or diesel engines will also eliminate the exhaust of millions of combustible engines thereby reducing pollution and heat, which could be factors in global warming.

Other objects of this invention and advantages of this invention will become apparent from a consideration of the ensuing description and drawings.

Thank you Lord for this inspiration. Thank you Spirit of God for your guidance.

### SUMMARY

In accordance with the present invention, an apparatus includes an electrical-energy-using element (electric element) such as a light, an electrical or electronic component, a motor, or an electromechanical device, and a capacitive, ceramic-based electrical energy storage unit (EESU) that is capable of operating as a power source, possibly a primary power source, for the electrical element within the apparatus.

### DRAWINGS

### Figures

The following description includes discussion of figures having illustrations given by way of example of implementations of embodiments of the invention. The drawings should be understood by way of example and not by way of limitation. As used herein, references to one or more “embodiments” are to be understood as describing a particular feature, structure, or characteristic included in at least one implementation of the invention. Thus, phrases such as “in one embodiment” or “in an alternate embodiment” appearing herein describe various embodiments and implementations of the invention, and do not necessarily all refer to the same embodiment, however, they are also not necessarily mutually exclusive.

FIG. 1 shows an apparatus that uses an EESU as a power source for an electrical element.

FIG. 2 shows an apparatus that uses a prior art non-rechargeable chemical battery as a power source for an electrical element.

FIG. 3 shows an apparatus that uses a prior art rechargeable chemical battery as a power source for an electrical element.

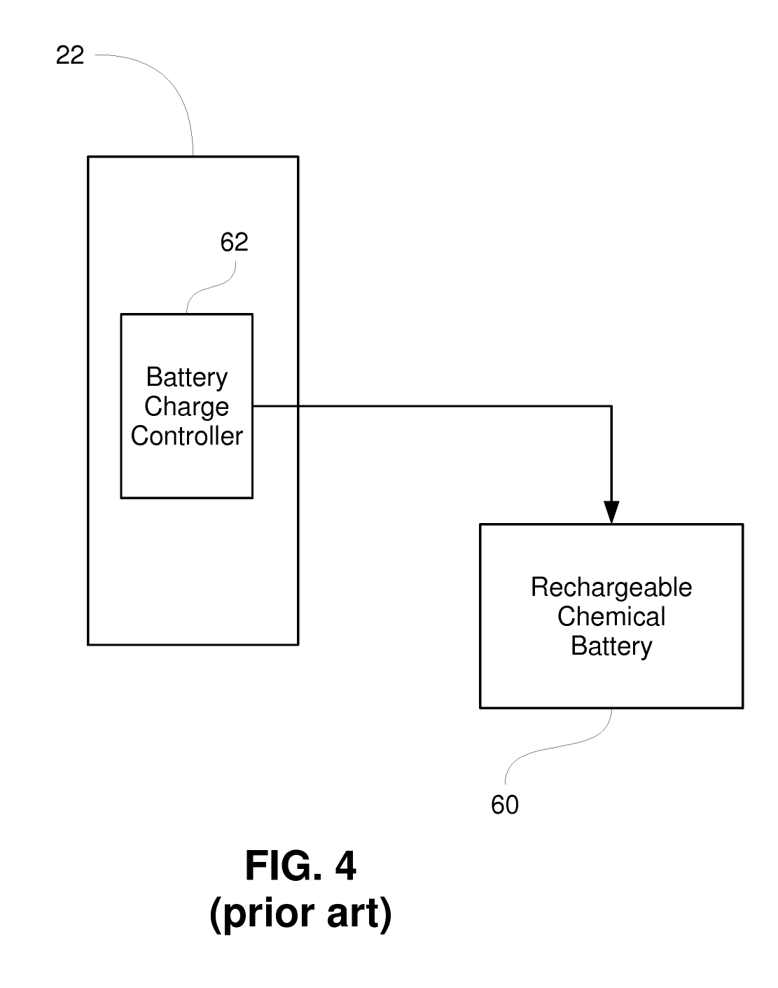

FIG. 4 shows a stand-alone battery charger in a configuration for charging a prior art rechargeable chemical battery.

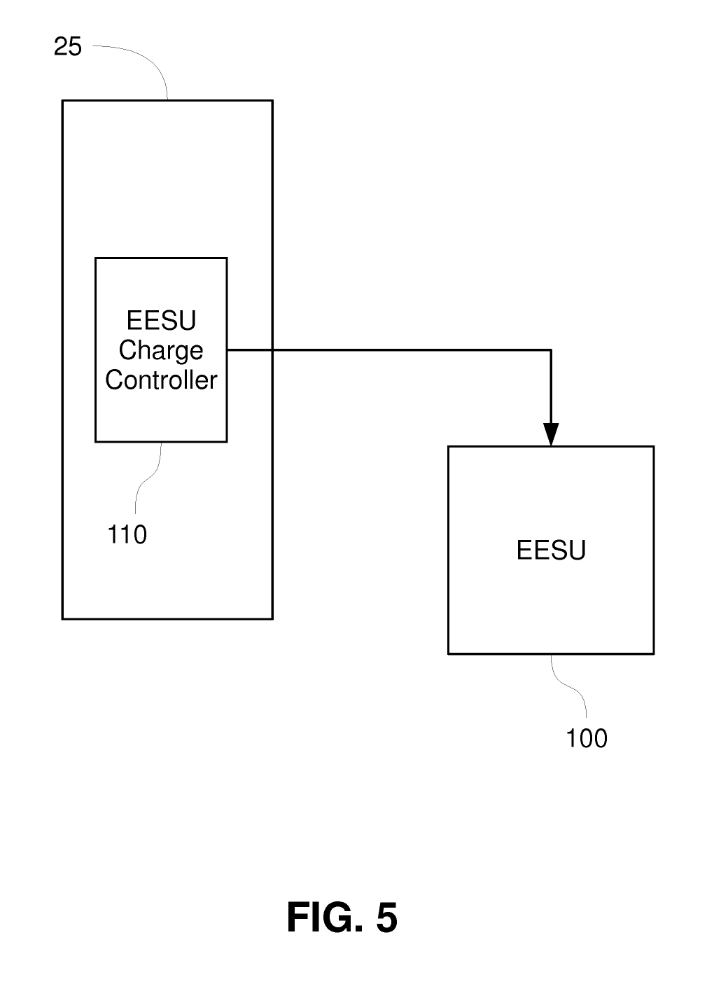

FIG. 5 shows a stand-alone charge controller in a configuration for charging a rechargeable EESU.

FIG. 6 shows a prior art combustible engine driving a mechanical element and getting its energy from a fuel reservoir.

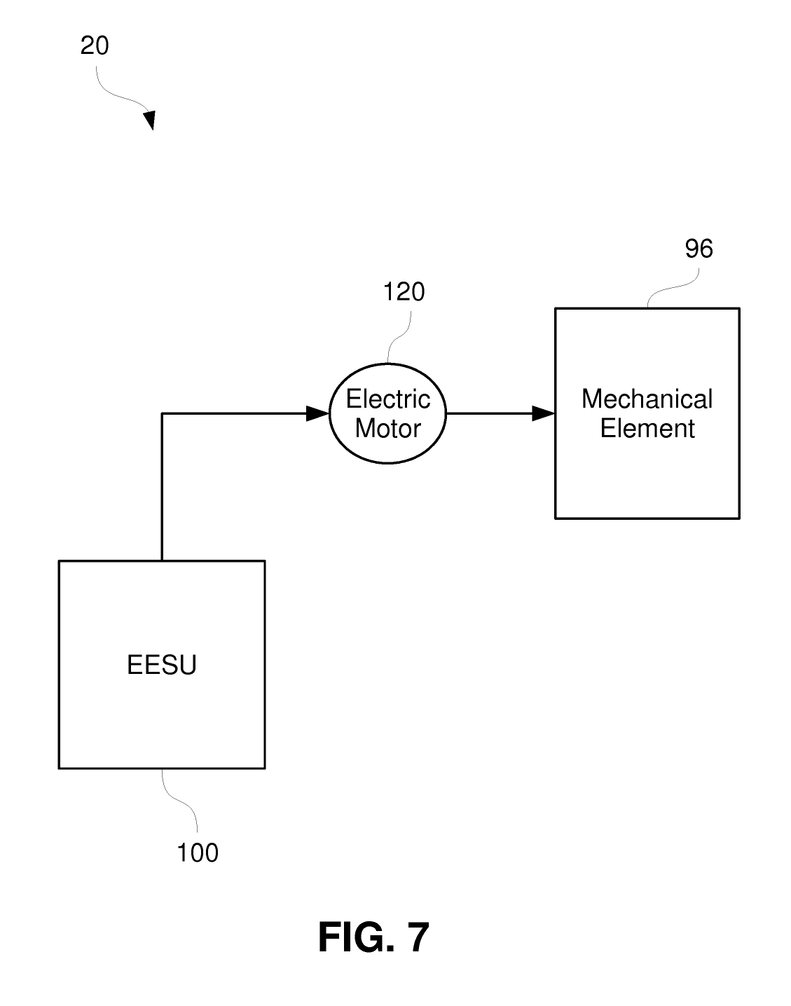

FIG. 7 shows the current invention with an electric motor driving a mechanical element and getting its electrical energy from an EESU power source.

### REFERENCE NUMERALS

20 An Apparatus
22 Battery Charger
25 EESU Charger
30 Electrical Element
50 Chemical Battery
60 Rechargeable Chemical Battery
62 Chemical Battery Charge Controller
90 Combustible Engine
92 Fuel Reservoir for Combustible Engine
96 Mechanical Element
100 Electrical Energy Storage Unit (EESU)
110 EESU Charge Controller
120 Electric Motor as an Electrical Element

### DETAILED DESCRIPTION AND OPERATION

### FIG. 1—Preferred Embodiment

Descriptions of certain details and implementations follow, including a description of the figures, which may depict some or all of the embodiments described below, as well as discussing other potential embodiments or implementations of the inventive concepts presented herein.

A preferred embodiment for an apparatus of the present invention is illustrated in FIG. 1. An apparatus 20 includes one or more electrical elements 30 such as lights, electronics, electrical systems, Motor-driven mechanical systems, or other electro-mechanical systems, and an EESU 100 energy source. This system is similar to the prior art systems of FIG. 2 and FIG. 3.

FIG. 2 shows an apparatus that also includes an electrical element 30, such as lights, electronics, electrical systems, Motor-driven mechanical systems, or other electro-mechanical systems, and a standard, non-rechargeable chemical battery 50 as the power source. In FIG. 3, a prior art rechargeable chemical battery 60 is used as the power source in a similar apparatus.

### Operation—FIGS. 1, 2, 3, 4, 5

The operation for the preferred embodiment of this invention, FIG. 1, is similar to that of a prior art apparatus 20 in that within the apparatus, electrical energy flows from the energy source, the EESU 100, to the electrical element 30, and the electrical element 30 operates in the manner for which it was designed.

An exemplary apparatus 20 would be a flashlight with an EESU 100 as the energy source and a light bulb as the electrical element 30. When the light bulb is placed in the circuit, energy flows from the EESU 100 to the light bulb and the light bulb illuminates.

Many prior art rechargeable batteries 60 utilize a stand-alone battery charger 22 as shown in FIG. 4 with a chemical battery charge controller 62 within it to control the charging process of at least one rechargeable battery 60. Similarly, FIG. 5 shows a charger 25 for the current invention with an EESU charge controller 110 built into it to control the charging of the EESU 100. Chargers 22 and 25 receive power from external energy sources (not shown) such as 110 Volt or 220 Volt wall outlets as can be found in many homes and businesses throughout the world.

The EESU 100 may be replaceable in an apparatus for charging purposes, or may be used as a single-charge power source.

### FIGS. 6, 7

### Additional Embodiment

FIG. 6 shows an apparatus 20 with mechanical elements 96 being driven by a combustible engine 90. The energy to fuel the combustible engine 90 comes from a fuel reservoir 92. Similarly, FIG. 7 shows an additional embodiment of the current invention where mechanical elements 96 are driven by an electric motor 120 which is the electrical element in this embodiment. The energy to drive the electric motor 120 comes from the EESU 100.

### Operation—FIGS. 6, 7

The operation for the apparatus 20 of this embodiment varies from the operation of the prior art in that an electrical motor 120 is utilized to drive the mechanical element 96 in this invention instead of a combustible engine 90 as in the prior art.

An exemplary apparatus 20 of this embodiment is similar to a gasoline powered weed trimmer. The block diagram of such a device is shown in FIG. 7. The common prior art weed trimmer, FIG. 6, utilizes a small gasoline engine 90 to drive a rotating mechanical trimmer 96. The energy for the gasoline engine 90 is stored in the weed trimmer in a small gasoline storage tank 92. A weed trimmer of the preferred embodiment, FIG. 7, would utilize an electric motor 120 to drive a rotating mechanical trimmer 96. Electrical energy to drive the electric motor 120 is supplied from the EESU 100.

### CONCLUSION, RAMIFICATIONS, AND SCOPE

Thus the reader can see that an apparatus of this invention is useful, convenient, safe for the user and for the environment, and is an enhancement over similar prior art devices in many ways. This enhanced usefulness to a user is due to the clean and safe high-density EESU power source that drives an electric element within the apparatus. The EESU allows an apparatus of this invention to be compact and highly portable, it allows it to be reusable and long-lived due to its nearly unlimited recharge capability, it allows it to readily recharge from nearly anywhere utilizing the current electric grid, and it allows it to have a great impact on reducing waste and pollution in country and in the world.

While the above description contains many specificities, these should not be construed as limitations on the scope of the invention, but rather as exemplifications of preferred embodiments thereof. Many other variations are possible. For example, the EESU need not be limited to the EESU of Richard Dean Weir, U.S. Pat. No. 7,466,536 B1. Other capacitive, ceramic-based electrical energy storage units utilizing ceramic sintered with other substances of high permittivity may also be utilized. Of course various storage capacities, various unit sizes, and various operating voltages may also be utilized.

Thus the scope of the invention should be determined by the appended claims and their legal equivalents, rather than by the examples given.

I claim:

1. An apparatus, comprising:
an electrical-energy-using element (electric element), and
a capacitive, ceramic-based electrical energy storage unit (EESU),
wherein said EESU is capable of operating as a power source for said electric element.

2. The electrical energy storage unit (EESU) of claim 1 wherein said EESU is rechargeable.

3. The electrical-energy-using element of claim 1 wherein said element includes a light.

4. The electrical-energy-using element of claim 1 wherein said element includes an electrical circuit.

5. The electrical-energy-using element of claim 1 wherein said element includes an electronic circuit.

6. The electrical-energy-using element of claim 5 wherein said electronic circuit includes computing circuitry.

7. The electrical-energy-using element of claim 5 wherein said electronic circuit includes display circuitry.

8. The electrical-energy-using element of claim 1 wherein said element includes an electric motor.

9. The electrical-energy-using element of claim 8, wherein said motor drives a mechanical element.

10. The electrical-energy-using element of claim 1 wherein said element includes an electro-mechanical component.

11. An apparatus, comprising:
an electrical-energy-using element (electric element), and
a capacitive, ceramic-based electrical energy storage unit (EESU), wherein
said EESU is capable of operating as the primary energy source for said electric element.

12. In an apparatus, a method of delivering electrical energy comprising:
supplying electrical energy to an electrical-energy-using element (electric element) from a capacitive, ceramic-based electrical energy storage system (EESU),
wherein said EESU is capable of operating as the primary energy source for said electric element.

13. The electrical energy storage unit (EESU) of claim 12 wherein said EESU is rechargeable.

14. The electrical-energy-using element of claim 12 wherein said element includes a light.

15. The electrical-energy-using element of claim 12 wherein said element includes an electrical circuit.

16. The electrical-energy-using element of claim 12 wherein said element includes an electronic circuit.

17. The electrical-energy-using element of claim 16 wherein said electronic circuit includes computing circuitry.

18. The electrical-energy-using element of claim 16 wherein said electronic circuit includes display circuitry.

19. The electrical-energy-using element of claim 12 wherein said element includes an electric motor.

20. The electrical-energy-using element of claim 12 wherein said element includes an electro-mechanical component.
